(19) United States
(12) Patent Application Publication
(10) Pub. No.: US 2007/0197727 A1
(43) Pub. Date: Aug. 23, 2007

(54) Multi component coating composition

(76) Inventors: Laura Ann Lewin, Greenville, DE (US); James William O'Neil, Chadds Ford, PA (US); Carl Brent Douglas, Boothwyn, PA (US); Denise Elizabeth Fiori, Trumbull, CT (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/706,446

(22) Filed: Feb. 13, 2007

Related U.S. Application Data
(60) Provisional application No. 60/773,871, filed on Feb. 16, 2006.

(51) Int. Cl. C08J 3/24

(52) U.S. Cl. 525/123; 525/440

(57) ABSTRACT

The present invention is directed to a multi component coating composition that includes a crosslinkable, crosslinking and catalyst components. The catalyst component includes organo zinc cocatalysts, organo tin catalysts, and carboxylic acids. The catalyst component provides long pot life to a pot mix obtained by mixing the aforementioned with components while simultaneously providing a coating resulting from the pot mix with desired coating properties, such as desired early hardness of a coating resulting from a relatively low temperature baking cure cycle.

### CROSS-REFERENCE TO RELATED APPLICATION

This application claims priority under 35 U.S.C. §119 from U.S. Provisional Application Ser. No. 60/773,871, filed Feb. 16, 2006.

### FIELD OF INVENTION

This invention generally relates to multi component curable coating compositions used in automotive refinish and Original Equipment Manufacturing (OEM) applications and it particularly relates to two pack (2K) coating compositions that have desired pot life, which upon cure under low temperature baking conditions provide coatings having desired early hardness. The invention also relates to those compositions having low VOC (volatile organic content) and to the process for producing coatings resulting from such coating compositions.

### BACKGROUND OF INVENTION

A number of basecoat and clear coating compositions are utilized in coatings, such as, for example, basecoats and clearcoats, respectively. These coatings are used both in automotive OEM and refinish coating applications. These coatings provide a protective layer for the underlying substrate and can also have an aesthetically pleasing value.

In repairing damage, such as dents to auto bodies, the original coating in and around the damaged area is typically sanded or ground out by mechanical means, such as, for example, sandpaper. Some times the original coating is stripped off from a portion or off the entire auto body to expose the bare metal underneath. After repairing the damage, the repaired surface is coated, preferably with low VOC coating compositions, typically in portable or permanent low cost painting enclosures vented to atmosphere to remove the organic solvents from the freshly applied paint coatings in a safe manner from the standpoint of operator health and explosion hazard. Typically, the drying and curing of the freshly applied paint takes place within these enclosures at ambient or elevated temperatures. Furthermore, the foregoing drying and curing steps take place within the enclosure to also prevent the wet paint from collecting dirt in the air or other contaminants. In order to improve the productivity of the drying and curing steps, it is desirable to reduce the time required to conduct these steps.

In the past, several approaches have been used to improve the productivity of isocyanate crosslinked coatings. One approach was based on using higher Tg acrylic polymers (U.S. Pat. Nos. 5,279,862 and 5,314,953) and another on the use of reactive oligomers (U.S. Pat. No. 6,221,494 B1). Due to the high Mw and high Tg of such acrylic polymers, the fast dry was achievable, but the film vitrified and the faster cure was not achievable. The viscosity of these types of acrylic polymers was also comparatively high and thus that approach resulted in higher VOC. The reactive oligomer approach improved the appearance and the rate of cure of the coating at lower VOC, however these oligomers are difficult to make at high enough Tg needed to reduce the dry time. Moreover, the higher the amount of these oligomers in the coating compositions, the lower was the hardness of the resultant coatings.

Thus, a continuing need still exists for a coating composition that cures under low temperature baking conditions, more particularly those compositions having low VOC.

### STATEMENT OF THE INVENTION

The present invention is directed to a coating composition comprising a crosslinkable component, a crosslinking component and a catalyst component,

wherein said crosslinkable component comprises one or more crosslinkable polymers;

wherein said crosslinking component comprises one or more polyisocyanates having two or more isocyanate groups and;

wherein said catalyst component consists essentially of one or more organo zinc cocatalysts, one or more organo tin catalysts, and one or more C₁ to C₈ carboxylic acids.

### DETAILED DESCRIPTION OF THE PREFERRED EMBODIMENT

As used herein:

“Two-pack coating composition” means a coating composition having two components stored in separate containers. Typically, one container contains a crosslinkable component and optionally contains solvent and/or other adjuvants; the other container typically contains the crosslinking component and optionally solvent and/or other adjuvants. The containers containing the two components are typically sealed to increase the shelf life of the components of the coating composition. The components are mixed just prior to use to form a pot mix, which has a limited pot life, typically ranging from a few minutes (15 minutes to 45 minutes) to a few hours (4 hours to 8 hours). The pot mix is applied as a layer of a desired thickness on a substrate surface, such as an auto body. After application, the layer dries and cures at ambient or elevated temperatures to form a coating on the substrate surface having desired coating properties, such as, high gloss, mar-resistance and resistance to environmental etching.

“Low VOC coating composition” means a coating composition that includes the range of from 0.1 kilograms (1.0 pounds per gallon) to 0.72 kilograms (6.0 pounds per gallon), preferably 0.3 kilograms (2.6 pounds per gallon) to 0.6 kilograms (5.0 pounds per gallon) and more preferably 0.34 kilograms (2.8 pounds per gallon) to 0.53 kilograms (4.4 pounds per gallon) of the solvent per liter of the coating composition. All VOC's determined under the procedure provided in ASTM D3960.

“High solids composition” means a coating composition having solid component of above 30 percent, preferably in the range of from 35 to 90 percent and more preferably in the range of from 40 to 80 percent, all in weight percentages based on the total weight of the composition.

“GPC weight average molecular weight” or “Mw” means a weight average molecular weight measured by utilizing gel permeation chromatography. A high performance liquid chromatograph (HPLC) supplied by Hewlett-Packard, Palo Alto, Calif. was used. Unless stated otherwise, the liquid phase used was tetrahydrofuran and the standard was polymethyl methacrylate or polystyrene. Units given for the molecular weight are given in Daltons.

“Tg” means glass transition temperature which is measured in ° C. as determined by DSC (Differential Scanning Calorimetry). To measure the Tg by this method, the polymer samples were dried, preheated to 120° C., rapidly cooled to −100° C., and then heated to 150° C. at a rate of 20° C./min while data was being collected. The Tg was measured at the midpoint of the inflection using the half-height method.

“Polydispersity” means GPC weight average molecular weight divided by GPC number average molecular weight. The lower the polydispersity (closer to 1), the narrower will be the molecular weight distribution, which is desired.

“(Meth)acrylate” means acrylate and methacrylate.

“Polymer solids”, or “Component solids”, means a polymer or a component in its dry state.

“Crosslinkable polymer” means a compound, oligomer, polymer, copolymer, or a combination thereof having hydroxyl groups positioned directly on the backbone of the polymer, pendant from the backbone of the polymer, terminally positioned on the backbone of the polymer, or a combination thereof.

The uses of numerical values in the various ranges specified herein are stated as approximations as though the minimum and maximum values within the stated ranges were both being preceded by the word “about.” In this manner, slight variations above and below the stated ranges can be used to achieve substantially the same results as values within the ranges. Also, the disclosure of these ranges is intended as a continuous range including every value between the minimum and maximum average values including fractional values that can result when some of components of one value are mixed with those of different value. Moreover, when broader and narrower ranges are disclosed, it is within the contemplation of this invention to match a minimum value from one range with a maximum value from another range and vice versa.

The inventive coating composition comprises a crosslinkable component, a crosslinking component, and a catalyst component.

The crosslinkable component comprises a crosslinkable polymer, which ranges from 10 percent to 90 percent by weight, preferably from 20 percent to 80 percent by weight, more preferably from 25 percent to 75 percent by weight; the percentages being based on the total weight of the crosslinkable, crosslinking and catalyst component solids.

The crosslinkable polymer means hydroxyl functional compounds, oligomers, polymers, copolymers. The crosslinkable polymer suitable for use includes hydroxyl functional acrylic polymers, hydroxyl functional polyesters or a combination thereof.

Suitable hydroxyl functional acrylic polymers can be composed of polymerized monomers of styrene, α-methyl styrene, C₁ to C₈ alkyl(meth)acrylates such as methyl(meth)acrylate, butyl (meth)acrylate, isobutyl(meth)acrylate or ethyl hexyl(meth)acrylate, a C₃ to C₁₀ cycloalkyl(meth)acrylates such as isobornyl(meth)acrylate, cyclohexyl(meth)acrylate or a combination of these monomers and a hydroxy C₁ to C₈ alkyl(meth)acrylate such as hydroxy ethyl methacrylate, hydroxy propyl methacrylate, hydroxy butyl methacrylate, hydroxy ethyl acrylate, hydroxy propyl acrylate, hydroxy butyl acrylate or a combination of these hydroxyl functional (meth)acrylates.

Typically useful hydroxyl functional acrylic copolymers can be produced in any of the following methods. Examples of such useful monomer charges are hydroxyethyl methacrylate/hydroxy butyl acrylate/isobornyl acrylate and hydroxyethyl methacrylate/hydroxy propyl methacrylate/hydroxy butyl acrylate/isobornyl acrylate. Preferably, the hydroxy functional acrylic copolymer can be made from styrene, methyl methacrylate, 2-ethylhexyl methacrylate, and 2-hydroxyethyl methacrylate.

Suitable hydroxyl functional acrylic polymers can be linear, graft, branched, or a combination thereof and can have a Mw in the range of from 1,000 to 100,000, preferably in the range of from 2,000 to 20,000, more preferably in the range of from 3,000 to 15,000 and a Tg varying in the range of from −70° C. to 100° C., preferably in the range of from −50° C. to 90° C., and more preferably in the range of from −40° C. to 80° C. The hydroxy functional acrylic polymers can have a hydroxyl equivalent weight ranging from 200 to 1200, preferably, from 250 to 1000 and more preferably from 300 to 900. Hydroxyl equivalent weight is given as the molecular weight of the polymer divided by average number of hydroxyl groups per molecule as is known in the art.

The hydroxyl functional graft acrylic polymers can be produced by a polymerization process, described in U.S. Pat. No. 5,290,633, examples 1 and 2 on column 9 lines 15-57. Such graft acrylic polymers can be made using any of the monomers listed above, provided that such hydroxyl functional graft acrylic polymers have a hydroxy equivalent weight in the aforedescribed range.

The hydroxyl functional acrylic polymers having a low polydispersity are also suitable. U.S. Pat. No. 4,680,352, example 8 on column 12 lines 23 through 50 provides such an example. Such low polydispersity acrylic polymers can be made using the same monomers used for making linear acrylic polymers, provided that such polymers have a hydroxy equivalent weight in the aforedescribed range.

Conventional processes that are well known in the art can produce linear hydroxyl functional acrylic polymers. U.S. Pat. No. 6,984,693 example 1 on column line 10 through column 15 lines 18 provides suitable examples of a conventional acrylic synthesis process. Typically, solvent is added to a reactor and brought to reflux at elevated temperatures under an inert gas blanket, typically nitrogen gas. Optionally, before adding heat, the reactor can be fed with a portion of the monomer mixture and one or more initiators, such as the azo type catalysts, which include 2,2′-azobis (2,4 dimethylpentane nitrile); peroxides, such as, di-tertiarybutyl peroxide; and hydroperoxides. Commercially available peroxy type initiator t-butylperoxide or Triganox® B from AKZO NOBEL, Chicago, Ill., is suitable for use in the present invention. Upon attaining the desired polymerization temperature, the initiator and the monomer mixture are simultaneously fed to the reactor over a period of time. Optionally, a shot of hydroxyl containing monomer can be added towards the end of polymerization. It may also be desirable to add additional initiator upon completion of the addition of the monomer mixture to ensure completion of the polymerization process.

Solvents that can be used to form the hydroxyl functional acrylic polymers are ketones such as methyl amyl ketone, methyl isobutyl ketone, methyl ethyl ketone, aromatic hydrocarbons such as toluene, xylene, petroleum naphtha, alkylene carbonates such as propylene carbonate, n-methylpyrrolidone, ethers, esters, such as butyl acetate, and mixtures of any of the above.

Suitable hydroxy functional polyesters have a Mw varying in the range of from 200 to 7000, preferably varying in the range of from 300 to 6000, more preferably varying in the range of from 400 to 4000 and a Tg varying in the range of from −80° C. to 50° C., preferably varying in the range of −75° C. to 40° C. and more preferably varying in the range of −70° C. to 30° C. The hydroxy functional polyesters have a hydroxyl equivalent weight ranging from 100 to 1000, preferably, from 150 to 900 and more preferably from 200 to 800.

Suitable hydroxy functional polyesters can be produced by first reacting a multifunctional alcohol, such as but not limited to, pentaerythritol, hexanediol, trimethyol propane with diacids or anhydrides, for example, hexahydrophthalic anhydride or methylhexahydrophthalic anhydride to produce an acid functional polyester. These acid functional polyesters are typically prepared by reacting multifunctional alcohol with less than a stoichiometric amount of the diacid or anhydride.

The acid functional polyester can then be reacted with a monofunctional epoxy under pressure at a reaction temperature in the range of from 60° C. to 200° C. Typical reaction time ranges from 1 hour to 24 hours, preferably, 1 hour to 4 hours. The foregoing two-step process ensures that the hydroxyl functionalities are uniformly distributed on each chain of the polyester to produce the hydroxy functional polyesters. Monofunctional epoxy suitable for use in the present invention include alkylene oxide having 2 to 12 carbon atoms. Ethylene, propylene and butylene oxides are preferred, ethylene oxide is more preferred. Other epoxies, such as, Cardura® E-10 glycidyl ester, supplied by Resolution Performance Products, Houston, Tex. can also be used. The details of producing the hydroxy functional polyesters are described in a PCT Publication WO 99/23131, procedure 2 page 12 lines 13 through 29, which was published on May 14, 1999.

Hydroxy functional polyesters when in the form of a linear or branched polymer can be any conventional polyester polymerized from polyacids, including cycloaliphatic polycarboxylic acids, and suitable polyols, which include polyhydric alcohols. The polyesters generally have terminal or pendant hydroxyl groups so that they can react with the crosslinking component.

Examples of suitable polyacids are cycloaliphatic polycarboxylic acids, such as, tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic acid and cyclobutanetetracarboxylic acid. The cycloaliphatic polycarboxylic acids can be used not only in their cis but also in their trans form or a mixture thereof. Examples of suitable other polycarboxylic acids, which, if desired, can be used together with the cycloaliphatic polycarboxylic acids, are aromatic and aliphatic polycarboxylic acids, such as, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid.

Suitable polyhydric alcohols that can be used to form the polyesters include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, tris(hydroxyethyl)isocyanate, polyethylene glycol and polypropylene glycol. If desired, monohydric alcohols, such as, butanol, octanol, lauryl alcohol, ethoxylated or propoxylated phenols can also be included along with polyhydric alcohols. One example of the commercially available polyester suitable for use is SCD-1040 polyester, which is supplied by Etna Product Inc., Chagrin Falls, Ohio.

Other useful hydroxyl functional polyesters include caprolactone polymers containing terminal hydroxyl groups which can be prepared by initiating the polymerization of lactones with one or more polyols, particularly a cycloaliphatic polyol, in the presence of tin catalysts via conventional polymerization techniques. Such caprolactone polymers are well known and described in Anderson et al. U.S. Pat. No. 5,354,797, on column 6 line 39 through column 7 line 16. A (ε)-caprolactone is typically employed as the lactone component in a 1/1 to 5/1 molar ratio with a cycloaliphatic diol. Typically useful cycloaliphatic polyol monomers include 1,4-cyclohexanediol, 1,4-cyclohexane dimethanol, and 2,2′-bis(4-hydroxycyclohexyl)propane. Preferred caprolactone polymers are formed from ε-caprolactone and 1,4-cyclohexanedimethanol reacted in a molar ratio of from about 2/1 to about 3/1.

The crosslinking component comprises one or more polyisocyanates, which range from 90 percent to 10 percent by weight, preferably from 80 percent to 20 percent by weight, more preferably from 75 percent to 25 percent; all percentages being based on the total weight of the crosslinkable, crosslinking and catalyst component solids. The polyisocyanate has on average 2 to 6, more preferably on average from 2 to 4 isocyanate groups per polymer chain.

The relative amount of polyisocyanate used in the coating composition is adjusted to provide a molar equivalent ratio of NCO/OH in the range of from 0.7 to 1.5, preferably in the range of from 0.8 to 1.4 and more preferably, in the range of from 0.9 to 1.3.

The polyisocyanate suitable for use in the present invention can include aromatic, aliphatic, and/or cycloaliphatic isocyanates, trifunctional isocyanates and isocyanate functional adducts of a polyol and a diisocyanate can be used. Typically useful diisocyanates are 1,6-hexamethylene diisocyanate, isophorone diisocyanate, 4,4′-biphenylene diisocyanate, toluene diisocyanate, bis cyclohexyl diisocyanate, tetramethylene xylene diisocyanate, ethyl ethylene diisocyanate, 2,3-dimethyl ethylene diisocyanate, 1-methyltrimethylene diisocyanate, 1,3-cyclopentylene diisocyanate, 1,4-cyclohexylene diisocyanate, 1,3-phenylene diisocyanate, 1,5-naphthalene diisocyanate, bis-(4-isocyanatocyclohexyl)-methane and 4,4′-diisocyanatodiphenyl ether. Typical trifunctional isocyanates include triphenylmethane triisocyanate, 1,3,5-benzene triisocyanate and 2,4,6-toluene triisocyanate. Trimers of diisocyanates also can be used, such as the trimer of hexamethylene diisocyanate, which is supplied by Bayer Corporation, Pittsburgh, Pa., under the trademark Desmodur® N-3390. Other suitable polyisocyanates, such as the trimer of isophorone diisocyanate are available from Bayer Corporation and include Desmodur® Z-4470BA polyisocyanates.

The catalyst component of the present invention includes one or more organo tin catalysts, one or more organo zinc cocatalysts, and one or more C₁ to C₈ carboxylic acids. It is believed, without reliance thereon that the presence of the catalyst component enhances the crosslinking of the functional groups in the crosslinkable component and the crosslinking component during curing. As a result, coatings having improved early hardness result. Generally, the catalyst component is present in the range of from about 0.02 percent to about 4 percent, preferably in the range of from 0.025 to 3.5 percent and more preferably in the range of from 0.03 percent to 3.0 percent of the catalyst, the percentages being in weight percentages based on the total weight of the crosslinkable, crosslinking and catalyst component solids. The catalyst component is preferably added to the crosslinkable component.

Suitable organo tin catalysts can be chosen from organotin carboxylates, particularly dialkyl tin carboxylates of aliphatic carboxylic acids, such as dibutyl tin dilaurate (DBTDL), dibutyl tin dioctoate, dibutyl tin diacetate, or a combination thereof. Dibutyl tin dilaurate or dibutyl tin diacetate is preferred. The organo tin catalyst is present in the coating composition in the range of from 0.001 percent to 0.5 percent by weight, preferably 0.005 percent to 0.07 percent by weight, more preferably in the range of from 0.003 percent to 0.1 percent by weight, all percentages based upon the crosslinkable, crosslinking and catalyst component solids.

Suitable organo zinc cocatalysts can be chosen from salts of aliphatic carboxylic acids, such as zinc octoate, zinc stearate, zinc laurate, zinc caprylate, zinc linoleate, zinc oleate, zinc palmitate, zinc resinate, zinc formate, zinc acetate, zinc propionate, zinc acetylacetonate, zinc lactate, or a combination thereof. Zinc octoate or zinc laurate is preferred. Other suitable zinc cocatalysts can include salts of aromatic acids such as zinc napthenate, zinc phenate, or a combination thereof. Zinc napthenate is preferred. Other suitable zinc cocatalysts can include di lower alkyl zinc compounds, such as dimethyl zinc, diethyl zinc or diaryl zinc compounds such as diphenyl zinc. Dimethyl zinc is preferred. Other suitable zinc cocatalysts that can be used are the reaction products of zinc oxide with C₁ to C₁₂ carboxylic acids, hydroxy C₁ to C₁₂ carboxylic acids, or a combination thereof. C₁ to C₁₂ carboxylic acids are preferred. Suitable C₁ to C₁₂ carboxylic acids can be chosen from formic acid, acetic acid, propionic acids, butyric acids, pentanoic acids, hexanoic acids, heptanoic acids, octanoic acids, nonanoic acids, decanoic acids, undecanoic acids, dodecanoic acids or a combination thereof. Hexanoic or octanoic acids are preferred. Hydroxy C₁ to C₁₂ carboxylic acids are obtained by reacting any of the aforedescribed C₁ to C₁₂ carboxylic acids with zinc oxide. Hydroxy hexanoic or hydroxy octanoic acids are preferred. The zinc cocatalysts are present in the composition in the range of from 0.01 percent to 1 percent by weight; preferably in the range of from 0.03 percent to 0.5 percent by weight, more preferably in the range of from 0.05 percent to 0.3 percent by weight, all percentages are based upon the crosslinkable, crosslinking and catalyst component solids.

The suitable C₁ to C₈ carboxylic acids include formic acid, acetic acid, propionic acids, butyric acids, pentanoic acids, hexanoic acids, heptanoic acids, octanoic acids, or a combination thereof. Acetic acid or propionic acid is preferred. The C₁ to C₈ carboxylic acids are present in the composition in the range of from 0.01 percent to 1.5 percent by weight, preferably in the range of from 0.03 percent to 0.8 percent by weight, more preferably in the range of from 0.05 percent to 0.5 percent by weight, all percentages are based upon the crosslinkable, crosslinking and catalyst component solids.

The coating composition can contain solvents used to reduce the viscosity of the coating composition required, for example, for spray application. Suitable solvents include organic solvents such as, aromatic hydrocarbons, such as, petroleum naphtha or xylenes; esters, such as, butyl acetate, t-butyl acetate, isobutyl acetate or hexyl acetate; ketones, such as, methyl ethyl ketone, methyl isobutyl ketone, or methyl amyl ketone; and glycol ether esters, such as, propylene glycol monomethyl ether acetate. The amount of organic solvent added depends upon the desired solids level as well as the desired amount of VOC of the composition. If desired, the organic solvent can be added to any of the components of the coating composition.

The coating composition of the present invention can also contain conventional additives, such as but not limited to, stabilizers, rheology control agents, flow agents, and toughening agents. Typically useful conventional formulation additives include leveling and flow control agents, for example, Resiflow®S (polybutylacrylate), BYK® 320 or 325 (silicone leveling agents, supplied by BYK Chemie, Wallingford, Conn.), BYK® 347 (polyether-modified siloxane, supplied by BYK Chemie, Wallingford, Conn.) and rheology control agents, such as, fumed silica. The inclusion of additional additives will, of course, depend on the intended use of the coating composition. Any additives that would adversely affect the clarity of the cured coating will not be included when the composition is used as a clear coating. The foregoing additives can be added to any of the components.

The amount of solvent added to the coating composition can be adjusted to provide the composition with a VOC in the range of from 0.12 kilograms (1.0 pounds per gallon) to 0.72 kilograms (6.0 pounds per gallon) of the solvent per liter of the coating composition.

To improve the weatherability of the coating resulting from the coating composition, 0.1 to 5 weight percent, preferably 0.5 to 2.5 weight percent and more preferably 1 to 2 weight percent of ultraviolet light stabilizer screeners, quenchers and antioxidants can be added to the composition, the percentages being based on the total weight of the crosslinkable, crosslinking and catalyst component solids. Typical ultraviolet light screeners and stabilizers include the following:

Benzophenones, such as, hydroxy dodecycloxy benzophenone, 2,4-dihydroxy benzophenone, and hydroxy benzophenones containing sulfonic acid groups.

Benzoates, such as, dibenzoate of diphenylol propane and tertiary butyl benzoate of diphenylol propane.

Triazines, such as, 3,5-dialkyl-4-hydroxyphenyl derivatives of triazine and sulfur containing derivatives of dialkyl-4-hydroxy phenyl triazine, hydroxy phenyl-1,3,5-triazine.

Triazoles, such as, 2-phenyl-4-(2,2′-dihydroxy benzoyl)-triazole and substituted benzotriazoles, such as hydroxy-phenyltriazole.

Hindered amines, such as, bis(1,2,2,6,6 entamethyl-4-piperidinyl sebacate) and di[4(2,2,6,6, tetramethyl piperidinyl)]sebacate; and any combination of any of the above.

If the coating composition is to be used as a pigmented topcoat or a basecoat, such as in a basecoat/clearcoat repair, pigments are added to the composition. In such a case, the composition typically contains pigments in a pigment to binder weight ratio of 1/100 to 350/100. If the coating composition is used as a basecoat or topcoat coating composition, inorganic and organic colored pigments, metallic flakes and powders, such as, aluminum flake and aluminum powders; special effects pigments, such as, coated mica flakes, coated aluminum flakes colored pigments may be used usually in combination with one of the following pigments. If the coating composition is used as a primer, conventional primer pigments are used in a pigment to crosslinkable, crosslinking and catalyst component weight ratio of 150/100 to 350/100. Typical of such pigments that are useful in primers are titanium dioxide, zinc phosphate, iron oxide, carbon black, amorphous silica, high surface area silica, barium sulfate, talc, chromate pigments for corrosion resistance, such as, calcium chromate, strontium chromate, zinc chromate, magnesium chromate, barium chromate and hollow glass spheres. These pigments are dispersed using conventional dispersing techniques, such as, ball milling, sand milling, and attritor grinding. The pigments that are useful in basecoat are conventional color pigments and can further include conventional metallic flakes.

The coating composition of the present invention is preferably formulated as a two-pack coating composition in which the crosslinkable component and the crosslinking component are stored in separate containers and wherein the catalyst component is included in the container containing the crosslinkable component or in the container containing the crosslinking component.

Alternatively, the crosslinkable component and the crosslinking component are stored in separate containers and wherein a portion of the catalyst component is included in the container containing the crosslinkable component and a remainder of the catalyst component is included in the container containing the crosslinking component. The first-pack of the two-pack coating composition which contains the crosslinkable component optionally has pigments dispersed therein, if the composition is pigmented.

The first pack of the coating composition which contains the crosslinkable component can also include solvents and other additives as those mentioned earlier.

In use, the first and second packs are mixed just prior to use for about 5 to 30 minutes to form a pot mix. If necessary, additional solvent can be added to the pot mix to adjust the viscosity and VOC of the coating composition to the desired level. Preferably, the pot mix has a viscosity in the range of from 10 to 30 seconds, preferably in the range of from 12 to 25 seconds, more preferably in the range of from 13 to 22 seconds. All viscosity ranges are measured using a Zahn #2 cup when measured at VOC of 0.53 kilograms (4.3 pounds per gallon) of solvent per liter of coating composition.

The pot mix generally has a useable shelf life in the range of from 10 minutes to 6 hours, preferable in the range of from 15 minutes to 5 hours, more preferably in the range of from 20 minutes to 4 hours. After this time, the pot mix becomes too viscous to apply to a substrate. The shelf life of the pot mix can be varied by adding solvent to the mix as is known to those skilled in the art. The presence of the catalyst component in the coating composition of the present invention unexpectedly provides long pot life to the pot mix. The amount of solvent in the coating composition may be adjusted to provide the composition with a VOC (volatile organic content) in the range of from 0.1 kilograms (1.0 pounds per gallon) to 0.72 kilograms (6.0 pounds per gallon) of the solvent per liter of the coating composition. Preferably, the coating composition contains in the range of from 0.3 kilograms (2.6 pounds per gallon) to 0.60 kilograms (5.0 pounds per gallon), more preferably the coating composition contains in the range of from 0.34 kilograms (2.8 pounds per gallon) to 0.53 kilograms (4.4 pounds per gallon) of solvent per liter of coating composition.

A layer of the pot mix is typically applied to a substrate by conventional techniques, such as, spraying, electrostatic spraying, roller coating, dipping or brushing. Generally, a layer having a thickness in the range of from 25 micrometers to 75 micrometers is applied over a metal substrate, such as automotive body, which is often pre-coated with other coating layers, such as an electrocoat, primer and a basecoat. The applied layer is then dried and cured at a temperature in the range of from ambient to 70° C., preferably in the range of from 30° C. to 65° C., more preferably in the range of from 35° C. to 60° C. Typically, the applied coating is dried and cured for 10 minutes to 240 minutes, preferably from 15 minutes to 180 minutes, more preferably from 20 minutes to 120 minutes.

The applied coating composition can be used as a refinish or OEM coating, such as a color basecoat over which a clearcoat is applied, or the coating composition can be used as the primerover which a color basecoat is applied, or it can be used as a pigmented topcoat. It should be noted that clearcoat refers to the state of the dried and cured coating. It is possible that clearcoat composition, as applied, is a milky, or transparent, or opaque, or translucent solution, mixture, or dispersion. Also, clearcoat compositions can optionally have a small amount of pigment present in order to tint the cured clearcoat.

The substrates suitable for use in the present invention include those used in automobile applications, such as bodies; any and all items manufactured and painted by automobile sub-suppliers; frame rails; commercial trucks and truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers; recreational vehicles, including but not limited to, motor homes, campers, conversion vans, vans, pleasure vehicles, pleasure crafts, snow mobiles, all terrain vehicles, bicycles and motorcycles; and automotive interior and exterior plastic and metal components; marine applications, such as personal watercraft, ships, amphibious vehicles, and boats; aviation applications, such as land-based and sea-based aircraft, gliders and helicopters; residential and commercial applications, such as new construction and maintenance thereof, including but not limited to walls of commercial and residential structures, such office buildings and homes; amusement park equipment; concrete surfaces, such as parking lots and drive ways; asphalt and concrete road surface, wood substrates, marine structures, such as jetties, piers, and offshore oil rigs; outdoor structures, such as bridges, towers; coil coatings; oil, gas and water pipelines and pipe fittings; railroad cars; printed circuit boards; machinery; OEM tools; signage; fiberglass structures; MDF (medium density fiber) furniture, PVC flooring; sporting goods; sporting equipment; radiators; fences; oil filters; drive shafts; mirrors; gas cylinders; fuel tanks; aluminum and steel wheels; reinforcing steel rods; wirework, supermarket trolleys, valves, tubes, pipe heating systems, lamp posts and traffic poles, water tanks, and inside lining of fire extinguishers.

These and other features and advantages of the present invention will be more readily understood, by those of ordinary skill in the art, from a reading of the following detailed description. It is to be appreciated those certain features of the invention, which are, for clarity, described above and below in the context of separate embodiments, can also be provided in combination in a single embodiment. Conversely, various features of the invention that are, for brevity, described in the context of a single embodiment, can also be provided separately or in any sub-combination. In addition, references in the singular can also include the plural (for example, “a” and “an” can refer to one, or one or more) unless the context specifically states otherwise.

### Test Procedures

Zahn #2 Viscosity was measured by the following procedure.

A Zahn #2 cup was completely immersed in the thoroughly mixed test material, then quickly lifted out of solvent and held in the atmosphere just above the test material, (about 6″), to permit observation of efflux.

The timer was started as the top of the cup leaves the surface.

The flow from the orifice was critically watched for the first sudden break at which point the timing was stopped.

The elapsed time in seconds was recorded as the viscosity of the material.

### Persoz Hardness Test

The change in film hardness of the coating was measured with respect to time by using a Persoz hardness tester Model No. 5854 (ASTM D4366), supplied by Byk-Mallinckrodt, Wallingford, Conn. The numbers of oscillations (referred to as Persoz number) were recorded. The applied layer of the coating composition applied over a test panel was baked at 60° C. for 30 minutes. The measurement was done once the coated panels reached ambient temperature. The desired after bake Persoz hardness ranges from 80 to 300, preferably 85 to 250 and more preferably from 90 to 200 oscillations. The Persoz hardness measurements were repeated one day after the baking step. The desired one day after bake Persoz hardness ranges from 80 to 500, preferably 100 to 400 and more preferably from 140 to 350 oscillations.

### Hardness (Fischer)

Hardness was measured using a Fischerscope® hardness tester (the measurement is in Newtons per square millimeter and the tester is available from Helmut Fischer GmbH and Co. KG of Sindelfingen, Germany). The applied layer of the coating composition applied over a test panel was baked at 60° C. for 30 minutes. The measurement was done once the coated panels reached the ambient temperature. The desired after bake Fischerscope® hardness ranges from 10 to 200, preferably 15 to 150 and more preferably from 20 to 125, all in Newtons per square millimeter. The Fischerscope® hardness measurements were repeated one day after the aforedescribed baking step. The desired one day after bake Fischerscope® hardness ranges from 15 to 400, preferably 20 to 300 and more preferably from 30 to 250, all in Newtons per square millimeter.

### BK Dry Time

Surface drying times in minutes of coated panels were measured according to ASTM D5895. The desired BK 3 dry time ranged from less than 4 hours, preferably less than 3 hours and more preferably less than 2 hours. The desired BK 4 dry time ranged from less than 6 hours, preferably less than 5 hours and more preferably less than 4 hours.

### EXAMPLES

Unless otherwise specified, all chemicals are available from the Aldrich Chemical Company, Milwaukee, Wis.

### Polymer 1

Part 1 (listed below) was charged to a reactor and heated to reflux (138° C.-142° C.). The ingredients of part 2 (listed below) were mixed and added to the reactor simultaneously with the premixed ingredients of part 3 over a three-hour period. When the addition of parts 2 and 3 was complete, part 4 (listed below) was added and the reaction was held at reflux for 1 hour. The reaction was cooled and filled out. The acrylic polymer had a weight solids content of 59.6% and a weight average molecular weight of 10,500.

| Ingredient | Parts by weight |
|---|---|
| Part 1 | |
| Xylene | 229.12 |
| Part 2 | |
| Styrene | 73.64 |
| Methyl methacrylate | 112.91 |
| 2-ethyl hexyl methacrylate | 223.74 |
| 2-Hydroxyethyl methacrylate | 73.64 |
| Part 3 | |
| t-butyl peroxyacetate | 11.78 |
| Xylene | 49.1 |
| Part 4 | |
| Xylene | 2.95 |
| Methyl ethyl ketone | 49.1 |

### Polymer 2

In a two reactor set, the first being operated at 1/10th the volume of the second, and connected to the second via a transfer line, Part 1 (listed below) was added and heated to 190° C. at 2.5 bar pressure. Part 2 (listed below) followed by Part 3 (listed below) were then charged to separate feed tanks, mixed and then fed to the first reactor over 280 minutes. Once the feeds increase the level in the first reactor to 90% of its normal operating volume, the reaction product from the first reactor was transferred to the second reactor so as to maintain a constant level in the first reactor. After 40 minutes of transfer from the first reactor to the second reactor, the second reactor was heated to reflux and Part 4 (listed below) was fed to the second reactor over 270 minutes. Once Part 2 and 3 feeds were completed, the entire contents of the first reactor were dumped into the second reactor. The second reactor was held at reflux for 1 hour at 157° C., cooled and emptied. All parts in the table below are by weight.

| Ingredient | Parts by weight |
|---|---|
| Part 1 | |
| Methyl amyl ketone | 6.8 |
| Part 2 | |
| Hydroxyethyl methacrylate | 22.2 |
| Isobornyl acrylate | 37.8 |
| Methyl amyl ketone | 1.6 |
| Part 3 | |
| Methyl amyl ketone | 20.4 |
| t-butyl peroxy acetate | 1.8 |
| Part 4 | |
| Methyl amyl ketone | 7.6 |
| t-butyl peroxy acetate | 1.8 |

The resulting copolymer had GPC Mn of 1704, GPC Mw of 3380 and Mw/Mn of 1.98 with near complete conversion of the monomer. The average number of functionalities (hydroxyl) is 4.8 per polymer chain. The Tg of the copolymer was 57.3° C.

### Polymer 3

The following monomer mixture (all in parts by weight) was charged to a reactor equipped with stirrer, condenser and nitrogen blanket:

| Ingredient | Parts by weight |
|---|---|
| methyl amyl ketone | 200 |
| pentaerythritol | 136 |
| Sanko ® HCA¹ | 5.46 |
| tetraethylammonium bromide | 4.19 |
| methylhexahydrophthalic anhydride | 457.9 |
| hexahydrophthalic anhydride | 196.2 |

¹Supplied by International Resources, Columbia, Maryland.

The reaction mixture was heated to 140° C. and then held at 140° C. for 3 hours. Then, 302.4 parts by weight of butyleneoxide was added to the reactor over a period of 4 hours while maintaining the reaction temperature at 140° C. After completion of the feed, the reaction temperature was held at 140° C. until acid number of less than 5 was attained. The resulting polymer was 80% solids with a Tg of 0° C.

### Coatings Examples

All the components of Table 1, part 1 were combined and then mixed with part 2 to form pot mixes, which were applied with a doctor blade over a separate phosphated cold roll steel panels rimed with a layer of PowerCron Primer supplied by PPG, Pittsburgh, Pa., to a dry coating thickness of 50 microns (2 mils) and then forced dried at 60° C. for 30 minutes. Then the panels were tested and the results are shown in Table 2 below.

TABLE 1

| | | Coating | Comparative | Comparative |
|---|---|---|---|---|
| Part | Material | Ex 1 | Ex 1 | Ex 2 |
| 1 | Polymer 2 | 18.17 | 18.18 | 18.19 |
| | Polymer 3 | 2.59 | 2.59 | 2.59 |
| | Polymer 1 | 62.29 | 62.30 | 62.34 |
| | Octa-Soligen Zinc-8¹ | 0.60 | 0 | 0.60 |
| | 2% DBTDL² in ethyl | 0.18 | 0.18 | 0.18 |
| | acetate | | | |
| | Acetic Acid | 0.16 | 0.16 | 0.00 |
| | acetone | 21.11 | 21.11 | 21.12 |
| | 10% tetraethylene | 0.0 | 0.57 | 0.0 |
| | diamine in xylene | | | |
| | Tinuvin ® 384³ | 0.67 | 0.67 | 0.67 |
| | Tinuvin ® 292³ | 0.64 | 0.64 | 0.64 |
| | Ethyl-3-ethoxy propionate | 7.76 | 7.76 | 7.76 |
| | Byk ® 306⁴ | 0.40 | 0.40 | 0.40 |
| | Byk ® 358⁴ | 0.48 | 0.48 | 0.48 |
| | Total (Part 1) | 115.04 | 115.03 | 114.98 |
| 2 | HC-7605, Chromabase | 64.96 | 64.97 | 65.02 |
| | activator⁵ | | | |
| | TOTAL | 180.00 | 180.00 | 180.00 |

¹Available from Lanxess Corporation, Pittsburgh, Pennsylvania.
²Available from Elf-Atochem, Philadelphia, Pennsylvania.
³Available from Ciba Specialty Chemicals, Tarrytown, New York. Tinuvin ® 384 is a UV light stabilizer. Tinuvin ® 292 is a hindered amine light stabilizer.
⁴Available from Byk Chemie, Wallingford, Connecticut. BYK ® 306 is an anti-slip agent. BYK ® 358 is a silicone additive for surface wetting and reducing the surface tension of coatings.
⁵Available from the DuPont Company, Wilmington, Delaware.

Example 1 and Comparative Example 2 had shorter BK3 dry times (97 and 92 min, respectively) than that of Comparative Example 1 (165 minutes). Example 1, which contained the catalyst combination of the present invention had shorter BK4 time (198 minutes) as compared to Comparative Example 2 and Comparative Example 1 (274 and 590 minutes). Example 1 and Comparative Example 2 were harder at cool down after a 60° C. (140° F.) bake as measured by Persoz (104 and 101) as compared to Comparative Example 1 (76). Thus, indicating better cure in the examples that contain the zinc catalyst than those without the zinc catalyst. Such difference was also seen in Fischerscopee hardness measurements (21 and 23 vs. 9 N/mm2) as compared to Comparative Example 1.

The pot life of Example 1 was better than that of Comparative Example 2, even though both Example 1 and Comparative Example 2 had similar hardness development and BK3 times. Comparative Example 1 has some what better pot life than that of Example 1 but it had much slower BK3 and BK4 times and was soft. Thus, the applicants have unexpectedly discovered that a unique combination in the catalyst component of the present invention provided increased pot life of the pot mix while still providing desired coating properties.

TABLE 2
TEST RESULTS

| | Coating | Comparative | Comparative |
|---|---|---|---|
| | Ex 1 | Ex 1 | Ex 2 |
| % Zinc Octoate | 0.30 | 0.00 | 0.30 |
| % Acetic Acid | 0.22 | 0.22 | |
| ppm dbtdl | 223 | 223 | 226 |
| ppm tetraethylene | | 792 | |
| diamine | | | |
| Zahn #2 initial | 16.5 | 16.4 | 16.8 |
| Zahn #2 after 1 hr | 17 | 16.6 | 17 |
| Zahn #2 after 2 hrs | 17.40 | 16.7 | 17.5 |
| Zahn #2 after 3 hrs | 18.00 | 17.2 | 18.6 |
| Zahn #2 after 4 hrs | 18.4 | 17.6 | 19.9 |
| BK 3 | 97 | 165 | 92 |
| BK 4 | 198 | 274 | 590 |
| Persoz 60° C. cool | 104 | 76 | 101 |
| Persoz 60° C. 1 day | 155 | 141 | 160 |
| Fisc 60° C. cool | 21 | 9 | 23 |
| Fisc 60° C. 1 day | 44 | 32 | 43 |

What is claimed is:

1. A coating composition comprising a crosslinkable component, a crosslinking component and a catalyst component,
wherein said crosslinkable component comprises one or more crosslinkable polymers;
wherein said crosslinking component comprises one or more polyisocyanates having on an average two or more isocyanate groups and;
wherein said catalyst component consists essentially of one or more organo zinc cocatalysts, one or more organo tin catalysts, and one or more C₁ to C₈ carboxylic acids.

2. The coating composition of claim 1 wherein said zinc cocatalyst is a reaction product of zinc oxide with C₁ to C₁₂ carboxylic acids, hydroxy C₁ to C₁₂ carboxylic acids, or a combination thereof.

3. The coating composition of claim 2 wherein said zinc cocatalyst is selected from the group consisting of zinc octoate, zinc napthenate, zinc formate, zinc acetate, zinc propionate, zinc acetylacetonate, zinc lactate, and a combination thereof.

4. The coating composition of claim 1 wherein said organo tin catalyst is dialkyl tin carboxylate of aliphatic carboxylic acid.

5. The coating composition of claim 1 wherein said organo tin catalyst is selected from the group consisting of dibutyl tin dilaurate, dibutyl tin dioctoate, dibutyl tin diacetate, and a combination thereof.

6. The coating composition of claim 1 wherein said C₁ to C₈ carboxylic acid is acetic acid.

7. The coating composition of claim 1 wherein weight percentage of zinc cocatalyst ranges from 0.01 percent to 1 percent, wherein weight percentage of organo tin catalysts ranges from 0.003 percent to 0.1 percent, and wherein weight percentage of carboxylic acids component ranges from 0.01 percent to 1.5 percent all weight percentages being based on the crosslinkable, crosslinking and catalyst component solids.

8. The coating composition of claim 1 wherein said crosslinkable polymer is a hydroxy functional acrylic polymer, hydroxy functional polyester or a combination thereof.

9. The coating composition of claim 1 or 8 wherein said crosslinkable polymer has GPC weight average molecular weight ranging from 200 to 100,000.

10. The coating composition of claim 1 or 8 wherein said crosslinkable polymer has a Tg ranging from −70° C. to 100° C.

11. The coating composition of claim 8 wherein said hydroxy functional acrylic polymer is polymerized from a monomer mixture comprising hydroxy C₁ to C₈ alkyl(meth)acrylate; and styrene, α-methyl styrene, C₁ to C₈ alkyl(meth)acrylate, C₃ to C₁₂ cycloalkyl (meth)acrylate, or a combination thereof.

12. The coating composition of claim 8 wherein said hydroxy functional polyester is prepared by polymerizing one or more polyols and one or more lactones to provide said polyester with on average, two or more terminal hydroxyl groups.

13. The coating composition of claim 8 wherein said hydroxy functional polyester is prepared by:
(a) polymerizing one or more polyols and one or more dicarboxylic acids, anhydrides of said dicarboxylic acids or a combination thereof to form an intermediate; and
(b) contacting said intermediate with a monofunctional C₂ to C₈ alkylene oxide, a glycidyl ester, or a combination thereof.

14. The coating composition of claim 8 wherein said hydroxy functional polyester is prepared by:
(a) polymerizing one or more polyols and one or more dicarboxylic acids, anhydrides of said dicarboxylic acids or a combination thereof to form an intermediate; and
(b) contacting said intermediate with a caprolactone.

15. The coating composition of claim 1 wherein ratio of said isocyanate groups to said hydroxyl group ranges from 0.7 to 1.5.

16. The coating composition of claim 1 wherein said polyisocyanate is a trimer of isophorone diisocyanate, a trimer of hexamethylene diisocyanate, or a combination thereof.

17. The coating composition of claim 1 formulated as a two-pack composition wherein said crosslinkable component and said crosslinking component are stored in separate containers and wherein said catalyst component is included in said container containing said crosslinkable component or in said container containing said crosslinking component.

18. The coating composition of claim 1 formulated as a two-pack composition wherein said crosslinkable component and said crosslinking component are stored in separate containers and wherein a portion of said catalyst component is included in said container containing said crosslinkable component and a remainder of said catalyst component is included in said container containing said crosslinking component.

19. The coating composition of claim 1, 17 or 18 formulated as a refinish or OEM clear coating composition.

20. The coating composition of claim 1,17, or 17 formulated as a refinish or OEM basecoat composition.

21. The coating composition of claim 1,17, or 17 formulated as a refinish or OEM primer composition.

22. The coating composition of claim 20 wherein said crosslinkable component further comprises dispersed pigments.

23. The coating composition of claim 1 wherein when said crosslinkable, crosslinking and catalyst components are mixed to form a pot mix, said pot mix having a shelf life ranging from 20 minutes to four hours when said coating composition has a VOC of 0.52 kilograms per liter.
